(19) United States
(12) Patent Application Publication
(10) Pub. No.: US 2008/0231754 A1
(43) Pub. Date: Sep. 25, 2008

(54) System and method for dynamically establishing microdisplay driver offsets using brightness value in rear projection TV having dynamic iris control

(76) Inventors: Orlando Arreola, San Diego, CA (US); Vincent V. Du, San Diego, CA (US); Eiji Kono, San Diego, CA (US); Tuan pham, San Diego, CA (US); Yoshiaki Shimizu, San Diego, CA (US); Khoua Vang, Ramona, CA (US); Jesus Villalpando, Temecula, CA (US)

Correspondence Address: ROGITZ & ASSOCIATES, 750 B STREET, SUITE 3120, SAN DIEGO, CA, 92101, US

(21) Appl. No.: 11/726,565

(22) Filed: Mar. 22, 2007

(51) Int. Cl. H04N 5/57

(52) U.S. Cl. 348/687; 348/E05.119

(57) ABSTRACT

In a rear projection microdisplay TV with dynamic iris control, sensed average picture level (APL) or other sensed brightness level is used to dynamically establish microdisplay driver offsets including white balance.

### I. FIELD OF THE INVENTION

The present invention relates generally to systems and methods for using brightness values to dynamically establish display driver offsets in rear projection TVs having microdisplays with dynamic iris control.

### II. BACKGROUND OF THE INVENTION

Many modern video displays such as the Sony Grand Wega™ television use three microdisplays, one each for the primary colors of red, green, and blue. Each microdisplay can be, e.g., a liquid crystal display (LCD). To display a picture on the screen, the LCDs are illuminated by a bright lamp and through a set of lenses and prisms the final image is expanded to fill relatively large screens.

As understood herein, it is difficult at best to manufacture LCDs to have precisely uniform thicknesses, and even very small variations in thickness cause non-uniformity in the screen display such that some areas of the screen might appear to be brighter than others or tinged with artificial color. This undesirable appearance is magnified when the output of the LCD is optically expanded as is done in microdisplay televisions.

Accordingly, the present invention recognizes that certain “offsets” must be applied to the drivers of microdisplays. Among the offsets are offsets for uniformity, white balance, and other parameters colloquially referred to as “SCON” and “SBRT”.

As further understood herein, dynamically variable irises have been provided at the input of the microdisplay LCDs to provide improved brightness and contrast expression especially in darker scenes. The present invention critically recognizes, however, that the introduction of dynamically variable irises implicates the need to adjust the driver offsets to optimize display performance during operation of the TV, particularly with an eye to improving what is referred to as “black level” of the display.

### SUMMARY OF THE INVENTION

A rear projection microdisplay TV with dynamic iris control is disclosed in which brightness level is used to dynamically establish at least one microdisplay driver offset such as but not limited to an offset for uniformity and/or white balance. Average picture level (APL) may be used to dynamically establish the microdisplay driver offset. In non-limiting implementations the APL may be sensed from the DC component of an output of a TV processor.

In another aspect, a rear projection TV has plural microdisplays illuminating a screen, and a display driver controls the microdisplays. Means are provided for dynamically sensing a signal representative of display brightness and generating an output representative thereof. Also, means are provided for sending an offset correction signal to the display driver based at least in part on the output of the sensing means.

In yet another aspect, a signal representative of a demanded brightness of a TV is obtained and used in turn to obtain offset input. The offset input is applied to a display driver to optimize display performance for black level.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting microdisplay TV; and

FIG. 2 is a flow chart of non-limiting logic that can be used to establish display driver offset adjustments in the TV shown in FIG. 1.

### DETAILED DESCRIPTION OF THE PREFERRED EMBODIMENT

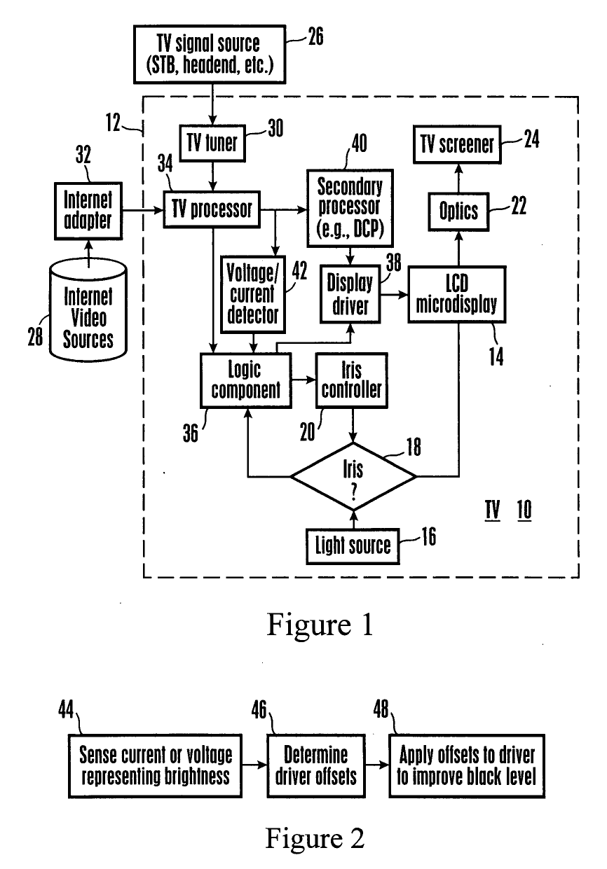

Referring initially to FIG. 1, a TV is shown, generally designated 10, that includes a housing 12 holding, in the preferred non-limiting embodiment, the components of a rear projection TV with red, green, and blue microdisplays 14. The microdisplays 14 may be LCDs that are illuminated by one or more lamps 16 through a dynamically variable iris 18, with the iris 18 being controlled by an iris controller 20 in accordance with dynamic iris control principles known in the art to establish display brightness. Light from the microdisplays 14 passes through optics 22 in accordance with rear projection TV principles known in the art to illuminate a screen 24 which is viewed by TV viewers.

The images displayed on the screen 24 can come from one or more sources, including a TV signal source 26 such as a set-top box, cable or satellite head end, etc. as well as various Internet audio-video sources 28. The TV signal source 26 communicates with a TV tuner 30 while the Internet sources 28 may communicate with, e.g., an Internet adapter 32 that is connected to or housed within the housing 12. Audio-video programs are sent from both the TV tuner 30 and, when provided, the Internet adapter 32 to a TV processor 34 as shown.

The TV processor 34 can control the iris controller 20 and, thus, the iris 18 through a logic component 36 that may be an integrated circuit or other logic component for at least in part executing the logic below. As shown, the logic component 36 receives signals from the TV processor 34 and a feedback signal from the iris 18 to send control signals to the iris controller 20.

The TV processor 34 can also send pixel display information to a display driver 38 which in turn drives the microdisplays 14 in accordance with principles known in the art to render a demanded image on the TV screen 24. In the non-limiting embodiment shown, the TV processor 34 may include circuitry that provides viewer control for displaying clear, stable images, as well as circuitry that maintains the integrity of a converted signal by minimizing image loss in the scaling process. The TV processor 34 may also include so-called “reverse pulldown” circuitry, which allows optimum performance of film-based video source displays. As shown in FIG. 1, the TV processor 34 may work in concert with a secondary processor such as a digital component processor (DCP) which fine tunes the signal and makes adjustments to improve overall contrast and sharpness before the image is displayed, with the output of the secondary processor 40 being supplied to the display driver 38 as shown.

In accordance with present principles, a sensor of current and/or voltage and/or other parameter representing actual display brightness is provided for purposes to be shortly disclosed. In the embodiment shown in FIG. 1, a voltage and/or current detector 42 receives an input representing average picture level (APL) from the output of the TV processor 34, and the detector 42 provides input to the logic component 36 as shown. In accordance with logic below, based on the APL or other brightness-indicating signal from the detector 42, the logic component 36 establishes and sends to the display driver 38 various offsets that are empirically determined for the particular TV model versus the measured brightness level to optimize display performance based on brightness. Among the one or more offsets that may be dynamically established in accordance with present principles are uniformity, white balance, and SCON/SBRT offsets.

While the non-limiting embodiment shown in FIG. 1 includes plural processors and logic components, greater or fewer logic components/processors may be used.

Now turning to FIG. 2, the overall logic of the invention may be seen. Commencing at block 44 the current and/or voltage and/or other parameter representing brightness as embodied in, e.g., the DC portion of the signal from the TV processor 34 and referred to from time to time as APL is sensed by the detector 42. The brightness is sent to the logic component 36, which then determines one or more of the above-discussed offsets and which then applies the offsets to the display driver 38 at block 48.

The offsets may be obtained using a table lookup in which the brightness level is used as entering argument to obtain table values corresponding to one or more offsets. The values may be used in subsequent algorithms to normalize the values. Or, no table per se need be used, but rather empirically-determined values that depend on brightness can be obtained and inserted into offset algorithms that are empirically tailored for the particular TV geometry. For instance, brightness-dependent offset correction values can be obtained from a data store in the TV and added to (or subtracted from) the core offset values for the parameters discussed above. In any case, the brightness-dependent offset corrections are empirically determined to optimize display performance, and specifically to improve black level for various iris positions.

While the particular SYSTEM AND METHOD FOR DYNAMICALLY ESTABLISHING MICRODISPLAY DRIVER OFFSETS USING BRIGHTNESS VALUE IN REAR PROJECTION TV HAVING DYNAMIC IRIS CONTROL is herein shown and described in detail, it is to be understood that the subject matter which is encompassed by the present invention is limited only by the claims.

What is claimed is:

1. A rear projection microdisplay TV with dynamic iris control, in which sensed brightness level is used to dynamically establish at least one microdisplay driver offset.

2. The TV of claim 1, wherein average picture level (APL) is used to dynamically establish the microdisplay driver offset.

3. The TV of claim 2, wherein the offset is a white balance offset.

4. The TV of claim 2, wherein the offset is a uniformity offset.

5. The TV of claim 1, wherein microdisplays in the TV are illuminated by light passing through a dynamically controlled iris.

6. The TV of claim 2, wherein the APL is sensed from the DC component of an output of a TV processor.

7. A rear projection TV, comprising:
plural microdisplays illuminating a screen;
a display driver controlling the microdisplays;
means for dynamically sensing a signal representative of display brightness and generating an output representative thereof; and
means for sending an offset correction signal to the display driver based at least in part on the output.

8. The TV of claim 7, comprising an iris through which light passes to illuminate the microdisplays.

9. The TV of claim 7, wherein the offset correction signal is for white balance.

10. The TV of claim 7, wherein the offset correction signal is for uniformity.

11. The TV of claim 7, wherein the signal representative of display brightness is average picture level (APL).

12. The TV of claim 11, wherein the APL is sensed at the output of a TV processor.

13. The TV of claim 8, further comprising an iris controller controlling the iris and receiving signals from the means for sending.

14. A method comprising:
sensing a signal representative of a demanded brightness of a TV;
using the signal, obtaining offset input; and
applying the offset input to a display driver to optimize display performance for black level.

15. The method of claim 14, wherein the TV is a rear projection TV having plural microdisplays illuminating a screen, the display driver controlling the microdisplays.

16. The method of claim 15, wherein an iris through which light passes illuminates the microdisplays.

17. The method of claim 14, wherein the offset input is for white balance.

18. The method of claim 14, wherein the offset input is for uniformity.

19. The method of claim 7, wherein the signal representative of display brightness is average picture level (APL).

20. The method of claim 19, comprising sensing APL at the output of a TV processor.
